(19) United States
(12) Patent Application Publication
(10) Pub. No.: US 2025/0017411 A1
(43) Pub. Date: Jan. 16, 2025

(54) MULTI-STATION BEVERAGE-MAKING MACHING

(71) Applicant: Hamilton Beach Brands, Inc., Glen Allen, VA (US)

(72) Inventors: Koen Ambrose, Glen Allen, VA (US); Mark Romandy, Glen Allen, VA (US); Mark Steiner, Glen Allen, VA (US); Patrick Walraven, Glen Allen, VA (US)

(73) Assignee: Hamilton Beach Brands, Inc., Glen Allen, VA (US)

(21) Appl. No.: 18/221,169

(22) Filed: Jul. 12, 2023

(51) Int. Cl. A47J 31/44; A47J 31/057; A47J 31/46; A47J 31/52

(52) U.S. Cl. CPC A47J 31/4442; A47J 31/057; A47J 31/469; A47J 31/52

(57) ABSTRACT

A multi-functional beverage-making machine includes a housing, the housing defining a first serving station, a second serving station, and a control pad mounted on a front surface of the housing. The first serving station includes a first dispensing inlet, a first brew basket, a first dispensing outlet, and a first receptacle platform. The second serving station includes a second dispensing inlet, a second brew basket, a second dispensing outlet, and a second receptacle platform, wherein the second receptacle platform is separate from and positioned at least partially directly rearwardly of the first receptacle platform. The beverage-making machine further comprises: a water reservoir; a pump fluidly connected with the water reservoir; a heating unit; a three-way fluid diverting unit fluidly connected with the pump, the first dispensing inlet, and the second dispensing inlet; and a controller operatively connected with the control pad, the pump, the heating unit, and the three-way fluid diverting unit.

### FIELD OF THE INVENTION

The present invention relates generally to small appliances, and more specifically to beverage makers.

### BACKGROUND

Automatic drip coffeemakers are well known and widely used. They are effective to brew carafes of coffee, typically containing five to eight cups or more of liquid. Automatic drip coffee makers may also be used for brewing small batches (one to four cups).

A typical automatic drip coffeemaker includes a brew basket that contains ground coffee. The coffee grounds may be presented as loose grounds within a filter, within a sachet-style package, or in a “pod”-type package often referred to as a K-CUP®. Irrespective of the form of coffee grounds presented, heated water is conveyed to the brew basket and released, where it gravimetrically flows downwardly through the coffee grounds and into a receptacle such as a carafe, pot, mug or the like. Exemplary automatic drip coffeemakers are discussed in U.S. Pat. No. 5,001,969 to Moore et al.; U.S. Pat. No. 7,066,080 to Hsu; and U.S. Pat. No. 8,065,952 to Wang, the disclosures of which are hereby incorporated herein by reference in full.

Some coffeemakers are designed to brew coffee in different forms; for example, coffeemakers offered in the FLEXBREW® line of products available from Hamilton Beach Brands (Richmond, Virginia) include an insert that enables the user to choose between a pod or loose ground coffee. Moreover, another coffeemaker offered in the FLEXBREW® line of coffeemakers has two different side-by-side “stations,” one of which can brew a full pot or carafe, and the other of which brews a single serving (often utilizing a pod as described above). This coffeemaker can provide the user with the flexibility of brewing either a single serving, if that is all that is desired, or multiple servings in a pot or carafe.

It may be desirable to provide a coffeemaker having a different configuration that some consumers may prefer.

### SUMMARY

As a first aspect, embodiments of the invention are directed to a multi-functional beverage-making machine. The multi-functional beverage-making machine comprises a housing, the housing defining a first serving station, a second serving station, and a control pad mounted on a front surface of the housing. The first serving station includes a first dispensing inlet, a first brew basket, a first dispensing outlet, and a first receptacle platform. The second serving station includes a second dispensing inlet, a second brew basket, a second dispensing outlet, and a second receptacle platform, wherein the second receptacle platform is separate from and positioned at least partially directly rearwardly of the first receptacle platform. The beverage-making machine further comprises: a water reservoir; a pump fluidly connected with the water reservoir; a heating unit; a three-way fluid diverting unit fluidly connected with the pump, the first dispensing inlet, and the second dispensing inlet; and a controller operatively connected with the control pad, the pump, the heating unit, and the three-way fluid diverting unit.

As a second aspect, embodiments of the invention are directed to a multi-functional beverage-making machine comprising a housing, the housing defining a first serving station and a second serving station. The first serving station includes a first dispensing inlet, a first brew basket, a first dispensing outlet, and a first receptacle platform. and the second serving station includes a second dispensing inlet, a second brew basket, a second dispensing outlet, and a second receptacle platform. The first serving station includes a lever pivotally attached to the housing and positioned above the first dispensing outlet, the lever being movable about a generally horizontal and laterally-extending pivot axis. The housing has a longitudinal axis that is horizontal and perpendicular to the pivot axis of the lever, and the second receptacle platform is separate from and positioned at least partially directly rearwardly of the first receptacle platform. The beverage-making machine further comprises: a water reservoir; a pump fluidly connected with the water reservoir; a heating unit; a three-way fluid diverting unit fluidly connected with the pump, the first dispensing inlet, and the second dispensing inlet; and a controller operatively connected with a control pad, the pump, the heating unit, and the three-way fluid diverting unit.

As a third aspect, embodiments of the invention are directed to a beverage-making machine comprising a multi-functional beverage-making machine comprising a housing, the housing defining a first serving station and a second serving station. The first serving station includes a first dispensing inlet, a first brew basket, a first dispensing outlet, and a first receptacle platform, and the second serving station includes a second dispensing inlet, a second brew basket, a second dispensing outlet, and a second receptacle platform. The second brew basket is pivotally mounted to the housing and is movable between a brewing position, in which the second brew basket is located directly beneath the second dispensing inlet, and an access position, in which the second brew basket is pivoted away from the second dispensing outlet toward the first serving station. The beverage-making machine further comprises: a water reservoir; a pump fluidly connected with the water reservoir; a heating unit; a three-way fluid diverting unit fluidly connected with the pump, the first dispensing inlet, and the second dispensing inlet; and a controller operatively connected with a control pad, the pump, the heating unit, and the three-way fluid diverting unit.

As a fourth aspect, embodiments of the invention are directed to a multi-functional beverage-making machine comprising: a housing, the housing defining a first serving station and a second serving station. The first serving station includes a first dispensing inlet, a first brew basket, a first dispensing outlet, and a first receptacle platform, and the second serving station includes a second dispensing inlet, a second brew basket, a second dispensing outlet, and a second receptacle platform. The housing defines a horizontal longitudinal axis that extends through the first receptacle platform and the second receptacle platform and a horizontal lateral axis that is perpendicular to the longitudinal axis, and wherein a window is present in the housing that provides access to the second receptacle platform for the insertion and removal of a receptacle along the lateral axis. The beverage-making machine further comprises: a water reservoir; a pump fluidly connected with the water reservoir; a heating unit; a three-way fluid diverting unit fluidly connected with the pump, the first dispensing inlet, and the second dispensing inlet; and a controller operatively connected with a control pad, the pump, the heating unit, and the three-way fluid diverting unit.

### BRIEF DESCRIPTION OF THE FIGURES

FIG. 1 is a front perspective view of a multi-functional coffeemaker according to embodiments of the invention, wherein the brew basket of the large serving station is moved to its brewing position.

FIG. 2 is a perspective view of the coffeemaker of FIG. 1, wherein the brew basket of the large serving station is pivoted to its access position.

FIG. 3 is a side perspective view of the coffeemaker of FIG. 1, with the brew basket of the large serving station pivoted to its access position.

FIG. 4 is a side section view of the coffeemaker of FIG. 1.

FIG. 5 is a side perspective view of the coffeemaker of FIG. 1 with the divider and pot removed and with the brew basket of the large serving station pivoted to its brewing position.

FIG. 6 is a top view of the coffeemaker of FIG. 1 with the ceiling of the housing removed.

FIG. 7 is a schematic diagram illustrating the operative connections between the controller and various components of the coffeemaker of FIG. 1.

FIG. 8 is a front perspective view of multi-functional coffeemaker according to alternative embodiments of the invention.

FIG. 9 is a side perspective view of the coffeemaker of FIG. 8.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

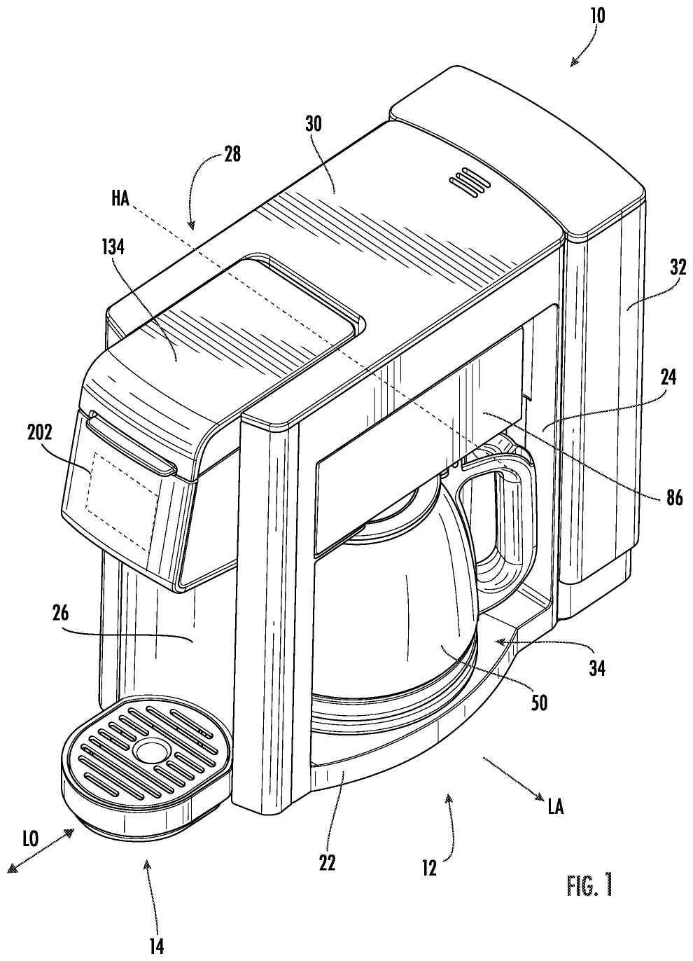

Referring now to the drawings, a multi-functional coffeemaker, designated broadly at 10, is shown in FIG. 1. The coffeemaker 10 has both a large serving station 12, which is configured to brew conventional coffee from either loose grounds or a large pod or packet, and a small serving station 14, which is configured to brew coffee from a pod. In contrast to typical multi-functional coffeemakers with stations that produce large and small servings, in which small and large serving stations are side-by-side, the coffeemaker 10 is designed so that the small serving station 12 is in front of the large serving station 14. (As used herein, the “front” direction is the direction facing the user as the user operates the coffeemaker 10; i.e., the direction that allows the user convenient access to a control panel 202 or similar display used to operate the coffeemaker 10). The “front” direction is also parallel with an underlying surface on which the coffeemaker 10 sits. The “rear” direction is the opposite of the “front” direction; thus, the user would face in the rearward direction when typically or conventionally positioned to operate the control panel 202 or display. As such, together the front and rear directions define a horizontal longitudinal axis LO for the coffeemaker 10. Also, as used herein, terms such as “side,” “lateral” and the like refer to directions that are along a horizontal axis LA that is perpendicular to the longitudinal axis. As sued herein with respect to these directions, a component is “directly forward” or “directly rearward” of another component if both components lie on a line that is parallel to the longitudinal axis.)

Details regarding the construction and operation of the coffeemaker 10 are set forth below.

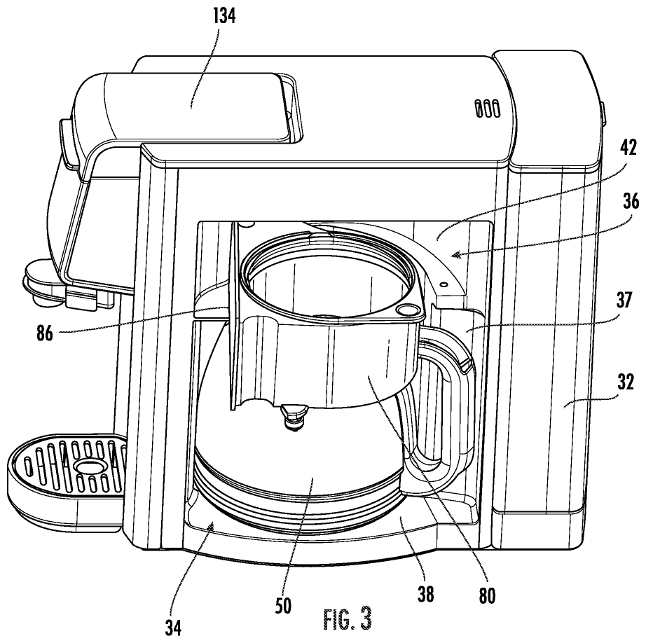

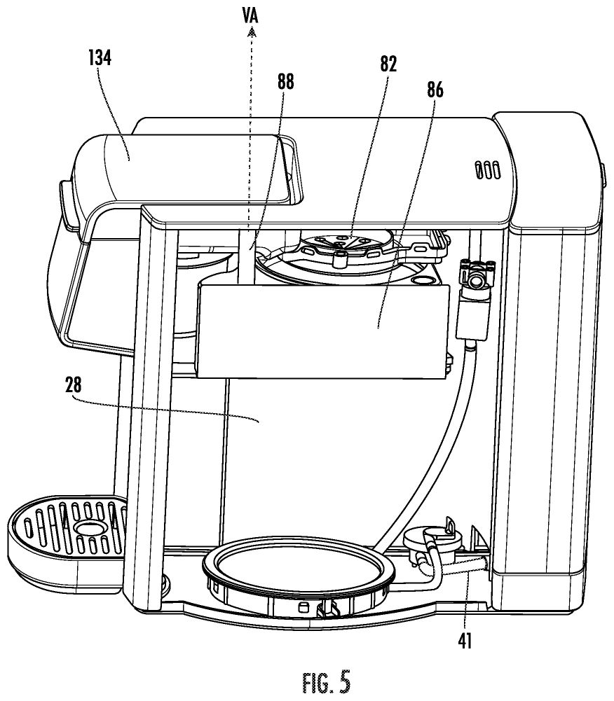

Referring to FIGS. 1-5, the coffeemaker 10 has an overall housing 20 that covers the exterior of the device. The housing 20 includes a base 22, a rear wall 24, a front wall 26, a side wall 28 (see FIG. 5), and a ceiling 30. The front wall 26 divides the large serving station 12 from the small serving station 14. The housing 20 also includes an arcuate divider 36 (see FIG. 3) that is positioned within the large serving station 12 and that spans the front and rear walls 24, 26. The divider 36 provides a floor 38 and a ceiling 40 of the large serving station 12, and also provides an arcuate side wall 42 on one side of the large serving station 12. However, on the side of the large serving station 12 opposite the side wall 42, a large window 34 is present that allows lateral access to the large serving station 12 (i.e., access is from the side). As shown, in some embodiments the divider 36 may include a recess 37 that can receive the handle of a receptacle such as a pot 50 when the pot 50 rests on the floor 38 (which serves as a platform for the pot 50 or other receptacle).

A water reservoir 32 is mounted on the base 22 behind the rear wall 24. The water reservoir 32 may have any configuration that is known to be suitable for use with a coffeemaker. For example, the water reservoir 32 may be detachable for easy filling. The water reservoir 32 may also be transparent to enable a user to discern the fill level. In some embodiments the water reservoir 32 may include a water filter (often as a removable insert within a holder). In the illustrated embodiment, at its lower end the water reservoir 32 has an outlet that feeds into a fitting. The fitting includes a spring-loaded seal that can prevent leakage through the outlet when water is not being pumped through the outlet.

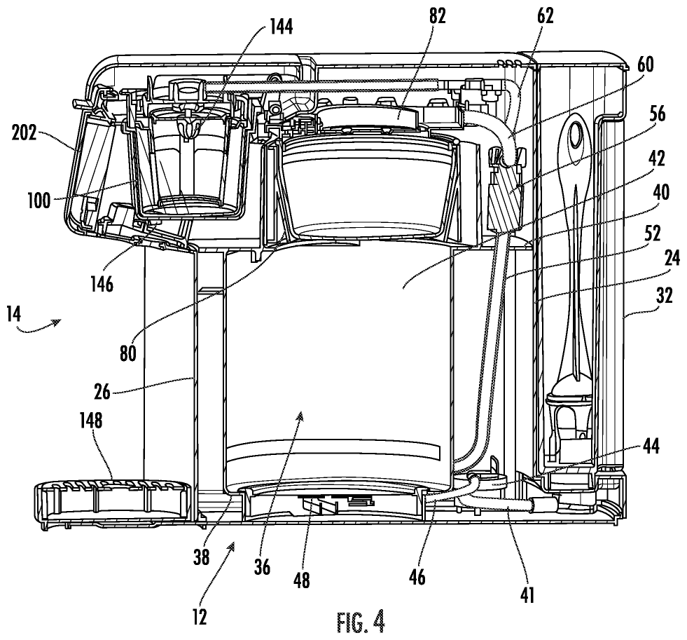

Referring now to FIG. 4, it can be seen that the reservoir 32 drains into a line 41 that is routed to a pump 44 that may also function as a flow meter. A line 46 leads to a heating element 48 that is positioned below the floor 38 of the large serving station 12. The heating element 48 both heats water for brewing and provides heat to a receptacle (e.g., the pot 50) that contains brewed beverage. A line 52 is routed from the heating element 48 upwardly to a three-way solenoid valve 56 that is positioned above the ceiling 40 of the large serving station 12. A line 60 leads from the solenoid valve 56 to a showerhead 82 of the large serving station, and a line 62 leads from the solenoid valve 56 to a dispensing needle 144 of the small serving station 14.

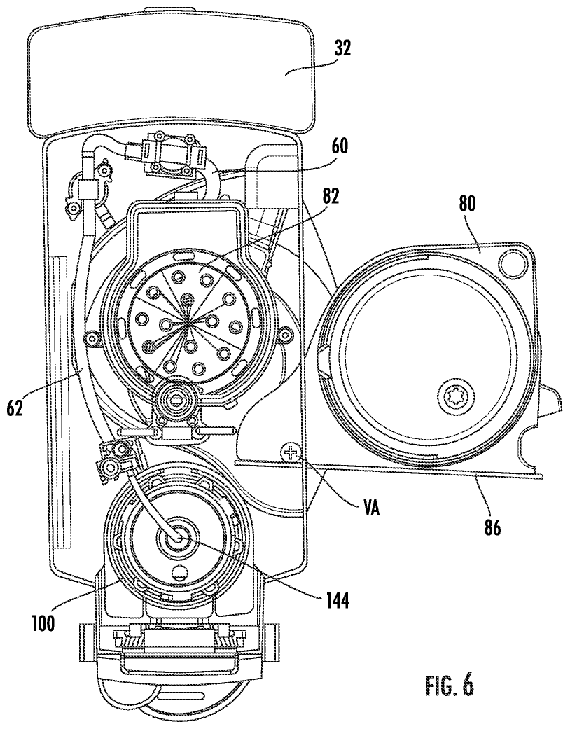

Referring now to FIGS. 4 and 6, the brew basket 100 of the small-serving station 14 is shown therein. The brew basket 100 is mounted beneath a pivoting lever 134 that pivots about a horizontal axis HA that is generally perpendicular to the longitudinal axis LO of the coffeemaker 10. The lever 134 has an outer cover and an inner cover that form a hollow cavity. A fitting is mounted in the inner cover 140; the fitting is in fluid communication at one end with the line 62 and at the opposite end with the aforementioned dispensing needle 144 that extends into the brew basket 100 and serves as the inlet thereto. An outlet 146 extends from the bottom surface of the brew basket 100. A receptacle platform 148 is present on the base 22 and positioned below the outlet 146 of the brew basket 130 in front of the front wall 26 (see FIG. 4).

Notably, the brew basket 100 may be configured so that it is “dual-brewing,” meaning that it can receive either loose grounds of coffee (either in a filtering packet or loose in a filter) or a coffee pod. If a coffee pod is to be used, typically a pod insert or adapter is positioned within the brew basket 100, with the pod placed therein. The insert or adapter typically includes structure, such as hollow needle in its base, that can pierce or puncture the pod at or near the lower end to provide an outlet therefrom. If loose grounds are to be brewed, another adapter configured to brew loose grounds or a packet containing same may be positioned in the brew basket 100. Such an adapter typically includes porous “filter” sections that enable water to drain therefrom while retaining coffee in the brew basket 100. In either event, the adapter and the inner cover 140 form a brew chamber. An exemplary dual-brewing arrangement of this type is discussed in U.S. Patent Publication No. 2014/0208952 to Starr et al., the disclosure of which is hereby incorporated herein in its entirety.

Referring now to FIGS. 3-6, the brew basket 80 of the large serving station 12 is shown therein. The brew basket 80 is largely of conventional construction and is positioned beneath the showerhead 82 to receive heated water therefrom. The brew basket 80 typically includes a separate filter (not shown) into which ground coffee is introduced. An outlet 84 is present in the lower surface of the brew basket 80 and provides a pathway for brewed beverage from the brew basket 80 to the pot 50 as it rests on the floor 38. A side wall 86 of the brew basket 80 is contiguous with an upper portion 39 of the divider 36.

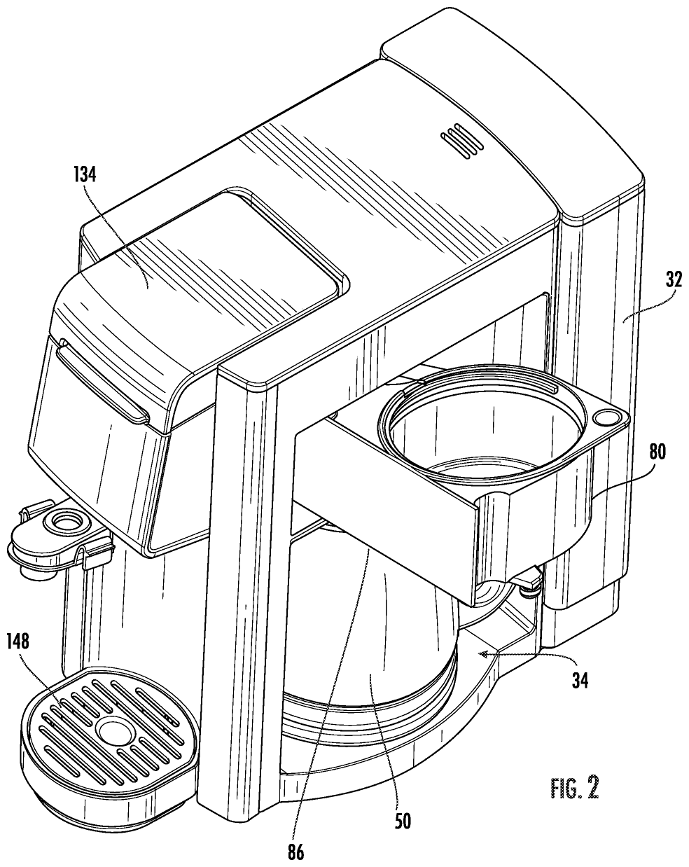

As seen in FIGS. 1-3 and 5, the brew basket 80 is pivotally mounted to the housing 20 and is movable between a brewing position (FIGS. 1 and 5), in which the brew basket 80 is positioned below the showerhead 82, and an access position (FIGS. 2 and 3), in which the brew basket 80 is pivoted to the side of the housing 20 and the base 22. The brew basket 80 is mounted to the housing 20 via a vertical post 88 (see FIG. 5) that enables the brew basket 80 to pivot about a vertical axis VA. In the illustrated embodiment, the axis VA is positioned just behind the front wall 26 of the housing 22, and thus toward the front portion of the large serving station 12. By positioning the axis VA toward the front of the large serving station 12, in its access position the brew basket 80 moves forwardly as well as laterally, which can locate the brew basket 80 in a convenient position for a user (who is typically positioned in front of the coffeemaker 10) to either add or remove grounds from the brew basket 80.

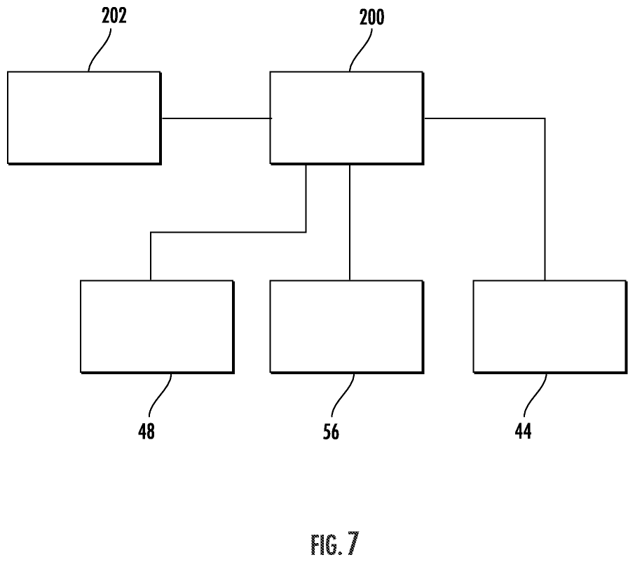

The coffeemaker 10 also includes a controller 200 (often in the form of a printed circuit board or the like) that controls operations of the coffeemaker 10. The controller 200 is operatively attached to the display pad 202, from which it receives a user's instructions, and with the pump/flow meter 44, the heating element 48, and the solenoid valve 56. The controller 200 is configured to activate or deactivate the pump/flow meter 44, the heating element 48, and the solenoid valve 56 based on the user's instructions (see FIG. 7).

In operation, a user fills the water reservoir 32 with water. If a small serving is desired, the user fills the brew basket 100 with grounds, which may be in pod, package or loose form. The user gains access to the brew backet 100 by pivoting the lever 134 upwardly and rearwardly about the axis HA. Once the brew basket 100 is filled, the user returns the lever 134 to its brewing position (as in FIG. 1). The user then selects, via the control pad 202, brewing a single serving with the small serving station 14. The user's instruction signals the controller 200 to cause brewing to occur: water is pumped from the reservoir 32 through the pump/flow meter 44, through the heating element 48, back through the pump/flow meter 44, and to the solenoid valve 56. The user's selection of a small serving causes controller 200 to signal the solenoid valve 56 to divert the heated water to the dispensing needle 144 and into the brew basket 100. Brewed beverage then flows from the brew basket 100 into a receptacle (such as a mug) placed on the receptacle platform 148.

If instead a large serving is desired, the user fills the brew basket 80 with grounds (typically loose grounds). As noted above, because the brew basket 80 pivots about the vertical axis VA, which is located near the front of the large serving station 12, in the access position of FIGS. 2, 3 and 6, the user is able to easily access the brew basket 80 for filling from a position in front of the coffeemaker 10. Once the brew basket 80 is filled, the user returns the brew basket 80 to its brewing position (FIGS. 1 and 5), then selects a large serving via the control pad 202. The user's instructions cause water to be conveyed from the reservoir 32 and heated as described above, then diverted by the solenoid valve 56 to the showerhead 82. The heated water flows through the grounds and the brew basket 80 and into the pot 50 positioned on the floor 38 of the divider 36, which as mentioned above serves as a platform for the pot 50.

Notably, the arrangement of the small serving station 14 and the large serving station 12 (i.e., with the small serving station 14 located in front of the large serving station 12, and more specifically with the floor/receptacle platform 38 being at least partially directly rearward of the receptacle platform 148 of the small serving station 12) can provide a coffeemaker having a smaller “footprint” than prior coffeemakers. This can be particularly helpful when countertop space is at a premium. In some embodiments, the base 22 of the coffeemaker 10 may have a width (measured in the lateral direction) of between about 8 and 12 inches, and a depth (measured in the longitudinal direction) of between about 12 and 16 inches; in other embodiments, the depth/width “aspect ratio” may be between about 1.3:1 and 1.5:1. One way to achieve a smaller footprint is (as shown) to provide lateral access to the large serving station 12 from the side of the coffeemaker 10 (i.e., through the window 34), wherein the window 34 is large enough to permit passage of the pot 50 therethrough. The positive effect of the overall smaller footprint can be maintained by orienting the pot 50 so that its handle 51 fits within the recess 37 in the divider 36. Access for the small serving station 14 remains in the front of the coffeemaker 10.

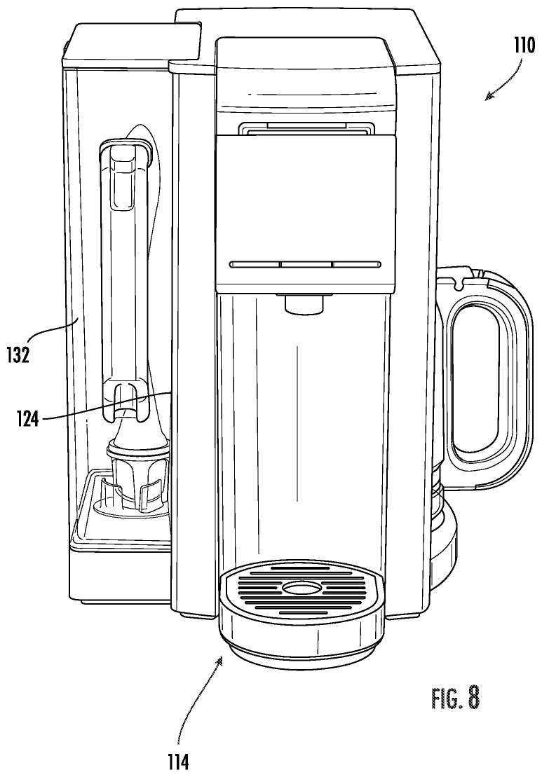

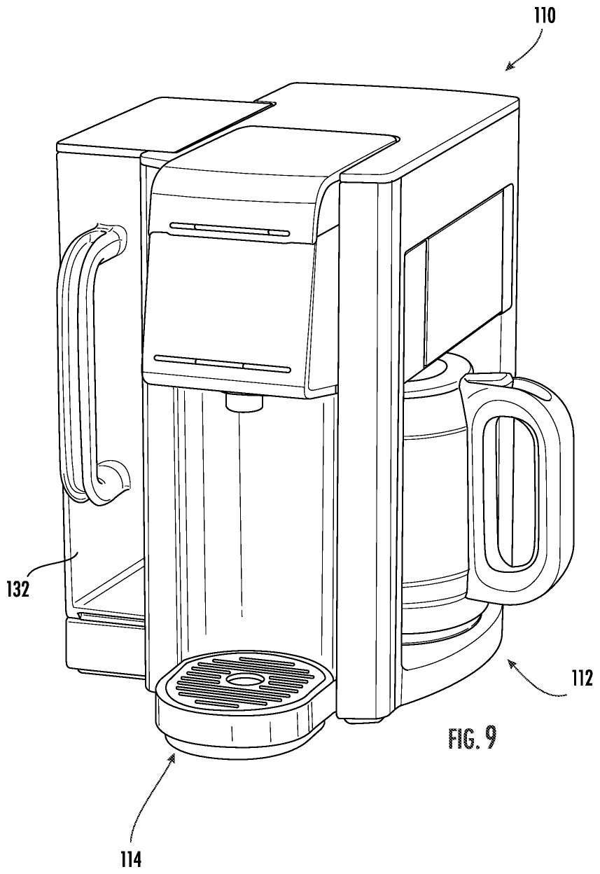

FIGS. 8 and 9 illustrate another coffeemaker, designated broadly at 110, in which the small serving station 114 is located in front of the large serving station 112, and wherein access to the large serving station 112 is through window 134 on the side of the coffeemaker 110. In this embodiment, however, the water reservoir 132 is located directly laterally of the sidewall 124 of the coffeemaker 110. The remainder of the coffeemaker 110 can remain the same, with the exception that water lines from the reservoir 132 to the pump/flow meter (not shown in FIGS. 8 and 9) are rerouted accordingly.

Those of skill in this art will appreciate that the coffeemakers 10, 110 may take other forms. In particular, the routing, pumping, and heating of water between the reservoir 32 and the showerhead 82 and the needle 144 may take any number of configurations known to those of skill in this are to be suitable for brewing beverages. As one example, the three-way solenoid valve 56 may be replaced with two different solenoid valves that act in the manner of a three-way valve. Other configurations or types of fluid diverting units that receive an input flow and divert the flow to one of two outlets (i.e., a “three-way diverting unit”) may also be employed,

As further examples, the manner in which water is supplied to the large and small serving stations may be varied (e.g., there may be multiple pumps and or multiple heaters, the fluid route may differ, etc.). As one specific example, the small serving station may be served by a first flow path that is routed from the reservoir to the needle via a first pump and a first heater, and the large serving station may be served by a second flow path that is routed from the reservoir to the showerhead via a second heater that “pushes” water through the heater (much like an automatic drip coffeemaker).

Moreover, the sizes of the serving stations may very (e.g., the small serving station may provide two or more servings rather than a single serving). Also, in some embodiments the showerhead 82 and/or the needle 144 may differ in configuration. Other variations may also be employed.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A multi-functional beverage-making machine, comprising:
a housing, the housing defining a first serving station, a second serving station, and a control pad mounted on a front surface of the housing;
wherein the first serving station includes a first dispensing inlet, a first brew basket, a first dispensing outlet, and a first receptacle platform; and
wherein the second serving station includes a second dispensing inlet, a second brew basket, a second dispensing outlet, and a second receptacle platform, wherein the second receptacle platform is separate from and positioned at least partially directly rearwardly of the first receptacle platform;
wherein the beverage-making machine further comprises:
a water reservoir;
a pump fluidly connected with the water reservoir;
a heating unit;
a three-way fluid diverting unit fluidly connected with the pump, the first dispensing inlet, and the second dispensing inlet; and
a controller operatively connected with the control pad, the pump, the heating unit, and the three-way fluid diverting unit.

2. The beverage-making machine defined in claim 1, wherein the first serving station is a small serving station, and the second serving station is a large serving station.

3. The beverage-making machine defined in claim 2, wherein the first brew basket is sized and configured to make a single beverage serving.

4. The beverage-making machine defined in claim 2, wherein the first brew basket is sized and configured to receive grounds in the form of a pod.

5. The beverage-making machine defined in claim 4, wherein the second brew basket is sized and configured to receive loose grounds.

6. The beverage-making machine defined in claim 1, wherein the water reservoir is mounted directly rearwardly of the second serving station.

7. The beverage-making machine defined in claim 1, wherein the water reservoir is mounted directly laterally of the second serving station.

8. The beverage-making machine defined in claim 1, wherein the second brew basket is pivotally mounted to the housing and is movable between a brewing position, in which the second brew basket is located directly beneath the second dispensing inlet, and an access position, in which the second brew basket is positioned laterally of the second dispensing inlet for the loading and unloading of grounds.

9. The beverage-making machine defined in claim 8, wherein the second brew basket pivots about a vertical pivot axis, and wherein the vertical pivot axis is positioned longitudinally between the first and second dispensing inlets.

10. The beverage-making machine defined in claim 1, wherein the first serving station includes a lever pivotally attached to the housing and positioned above the first dispensing outlet, the lever being movable about a generally horizontal and laterally-extending pivot axis.

11. A multi-functional beverage-making machine, comprising:
a housing, the housing defining a first serving station and a second serving station;
wherein the first serving station includes a first dispensing inlet, a first brew basket, a first dispensing outlet, and a first receptacle platform; and
wherein the second serving station includes a second dispensing inlet, a second brew basket, a second dispensing outlet, and a second receptacle platform;
wherein the first serving station includes a lever pivotally attached to the housing and positioned above the first dispensing outlet, the lever being movable about a generally horizontal and laterally-extending pivot axis;
wherein the housing has a longitudinal axis that is horizontal and perpendicular to the pivot axis of the lever, and wherein the second receptacle platform is separate from and positioned at least partially directly rearwardly of the first receptacle platform;
wherein the beverage-making machine further comprises:
a water reservoir;
a pump fluidly connected with the water reservoir;
a heating unit;
a three-way fluid diverting unit fluidly connected with the pump, the first dispensing inlet, and the second dispensing inlet; and
a controller operatively connected with a control pad, the pump, the heating unit, and the three-way fluid diverting unit.

12. The beverage-making machine defined in claim 11, wherein the first serving station is a small serving station, and the second serving station is a large serving station.

13. The beverage-making machine defined in claim 12, wherein the first brew basket is sized and configured to make a single beverage serving.

14. The beverage-making machine defined in claim 11, wherein the second brew basket is pivotally mounted to the housing and is movable between a brewing position, in which the second brew basket is located directly beneath the second dispensing inlet, and an access position, in which the second brew basket is positioned laterally of the second dispensing inlet for the loading and unloading of grounds.

15. The beverage-making machine defined in claim 14, wherein the second brew basket pivots about a vertical pivot axis, and wherein the vertical pivot axis is positioned longitudinally between the first and second dispensing inlets.

16. A multi-functional beverage-making machine, comprising:
a housing, the housing defining a first serving station and a second serving station;
wherein the first serving station includes a first dispensing inlet, a first brew basket, a first dispensing outlet, and a first receptacle platform; and
wherein the second serving station includes a second dispensing inlet, a second brew basket, a second dispensing outlet, and a second receptacle platform;
wherein the second brew basket is pivotally mounted to the housing and is movable between a brewing position, in which the second brew basket is located directly beneath the second dispensing inlet, and an access position, in which the second brew basket is pivoted away from the second dispensing outlet toward the first serving station;
wherein the beverage-making machine further comprises:
a water reservoir;
a pump fluidly connected with the water reservoir;
a heating unit;
a three-way fluid diverting unit fluidly connected with the pump, the first dispensing inlet, and the second dispensing inlet; and
a controller operatively connected with a control pad, the pump, the heating unit, and the three-way fluid diverting unit.

17. The beverage-making machine defined in claim 16, wherein the first serving station is a small serving station, and the second serving station is a large serving station.

18. The beverage-making machine defined in claim 17, wherein the first brew basket is sized and configured to make a single beverage serving.

19. A multi-functional beverage-making machine, comprising:
a housing, the housing defining a first serving station and a second serving station;
wherein the first serving station includes a first dispensing inlet, a first brew basket, a first dispensing outlet, and a first receptacle platform; and
wherein the second serving station includes a second dispensing inlet, a second brew basket, a second dispensing outlet, and a second receptacle platform;
wherein the housing defines a horizontal longitudinal axis that extends through the first receptacle platform and the second receptacle platform and a horizontal lateral axis that is perpendicular to the longitudinal axis, and wherein a window is present in the housing that provides access to the second receptacle platform for the insertion and removal of a receptacle along the lateral axis; and
wherein the beverage-making machine further comprises:
a water reservoir;
a pump fluidly connected with the water reservoir;
a heating unit;
a three-way fluid diverting unit fluidly connected with the pump, the first dispensing inlet, and the second dispensing inlet; and
a controller operatively connected with a control pad, the pump, the heating unit, and the three-way fluid diverting unit.

20. The beverage-making machine defined in claim 19, wherein the first brew basket is sized and configured to make a single beverage serving.
